(19) United States
(12) Patent Application Publication
(10) Pub. No.: US 2012/0297147 A1
(43) Pub. Date: Nov. 22, 2012

(54) Caching Operations for a Non-Volatile Memory Array

(75) Inventors: Kimmo Juhani Mylly, Ylojarvi (FI); Jani Klint, Kangasala (FI)

(73) Assignee: Nokia Corporation

(21) Appl. No.: 13/112,287

(22) Filed: May 20, 2011

(51) Int. Cl. G06F 12/08

(52) U.S. Cl. 711/143; 711/E12.017

(57) ABSTRACT

A method includes receiving in conjunction with data to be written at a non-volatile memory device an indication from a host that is descriptive of a write-back requirement for the data; and storing the data in a cache memory of the non-volatile memory device and selectively, depending on the indication, controlling whether the data is or is not written back from the cache memory to a non-volatile memory array that comprises a part of the non-volatile memory device.

### TECHNICAL FIELD

The exemplary embodiments of this invention relate generally to data storage devices and methods and, more specifically, relate to high storage capacity non-volatile semiconductor-based storage devices such as FLASH and to managedNAND types of storage devices.

### BACKGROUND

Certain abbreviations that appear below are defined as follows:

DRAM dynamic random access memory

eMMC embedded MultiMediaCard

JEDEC joint electron device engineering council

NAND Floating gate memory technology

ONFI open NAND flash interface

SRAM static random access memory

SSD solid state disk

UFS universal flash storage

In conventional mobile managed NAND devices (a NAND containing an integral memory controller/management function) there is no actual cache memory provided due at least to cost and power considerations. While there may be some memory controller SRAM present, as well as buffer memory in the NAND itself, these are simply temporary storage to buffer the data before it is programmed to the NAND (memory write) or delivered to the host (memory read). In some PC market managed NAND devices, such as SSDs, there can be a true cache memory, typically DRAM, included. In the SSD the data may be stored to the DRAM cache for some period of time before flushing the data to the NAND.

### SUMMARY

In accordance with the embodiments of this invention there is provided a method that comprises receiving in conjunction with data to be written at a non-volatile memory device an indication from a host that is descriptive of a write-back requirement for the data; and storing the data in a cache memory of the non-volatile memory device and selectively, depending on the indication, controlling whether the data is or is not written back from the cache memory to a non-volatile memory array that comprises a part of the non-volatile memory device.

Further in accordance with the embodiments of this invention there is provided an apparatus that comprises an interface for connecting said apparatus to a host; a volatile cache memory; a non-volatile memory array and a controller. The controller is connected with the interface, the cache memory and the non-volatile memory array. The controller is responsive to a receipt of data from the host with an indication that is descriptive of a write-back requirement for the data to store the data in the cache memory and to selectively, depending on the indication, control whether the data is or is not written back from the cache memory to the non-volatile memory array.

Further in accordance with the embodiments of this invention there is provided an apparatus that comprises means for receiving in conjunction with data to be written an indication from a host that is descriptive of a no write-back requirement for the data; and means for storing the data in a volatile cache memory of a memory device and for selectively, depending on the indication, controlling whether the data is or is not written back from the volatile cache memory to a non-volatile memory array of the memory device. The indication comprises at least one of an address in a range that exceeds an addressable range of the non-volatile memory array, at least one bit indicating that there is no write-back requirement for the data, an address associated with an address space separate from an address space associated with the non-volatile memory array, and a receipt of the data without an address.

### BRIEF DESCRIPTION OF THE DRAWINGS

The foregoing and other aspects of the embodiments of this invention are made more evident in the following Detailed Description, when read in conjunction with the attached Drawing Figures, wherein:

FIG. 1 is a block diagram of a system having at least one data processor, at least one memory that stores computer program code, a bus and a non-volatile mass storage device that is constructed and operated in accordance with the exemplary embodiments of this invention.

FIG. 2 is a logic flow diagram that shows a method in accordance with the exemplary embodiments of this invention.

FIGS. 3A-3F, collectively referred to as FIG. 3, depict various command/data transaction sequences for communication with the non-volatile mass storage device of FIG. 1 in accordance with embodiments of this invention.

### DETAILED DESCRIPTION

In typical high end mobile device there can be a large amount of data stored to a mass storage during run time. This data can include swap data (e.g., resulting from the swapping of application data from system DRAM to mass storage when the DRAM space is becoming full due to another application being launched) and different types of application run time data such as a web browser cache. This type of data may eventually be deleted and thus may not require non-volatile storage for a long period of time (e.g., if the mobile device is turned off, or the application is closed, this data may be simply deleted and not retained). A significant portion of this data can also be in small pieces, as well as “random” in nature, which can cause a significant load to a (block based) mass memory such as NAND. In addition the presence of this data can cause degradation of overall memory performance as well as an increased/accelerated wearing out effect of the NAND.

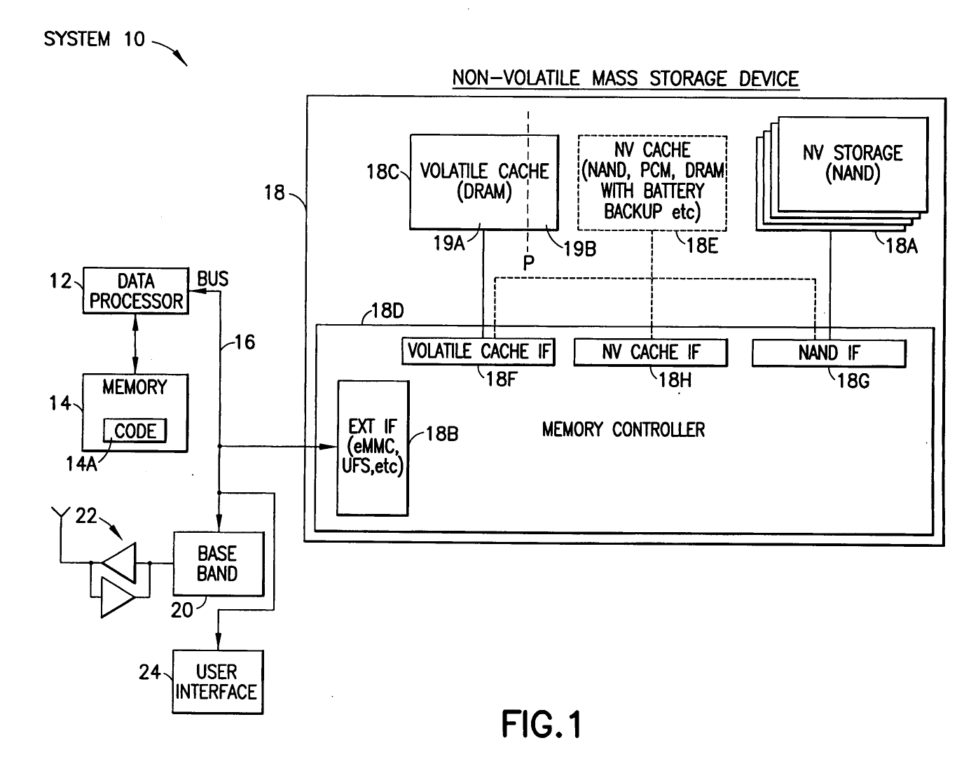

FIG. 1 is a block diagram of a system, such as a mobile system 10 (e.g., cellular phone, smart phone, tablet, etc.) having at least one data processor 12, at least one memory 14 (DRAM or DRAM in combination with NAND/OneNAND or SRAM in combination with NOR) that stores computer program code (instructions) 14A for execution by the data processor 12 as well as data that is used/generated during execution of the program code 14A, at least one data/address/command bus 16 and, connected to the bus 16, a non-volatile mass storage device 18 that is constructed and operated in accordance with the exemplary embodiments of this invention. The system 10 can include by example other components including one or more wireless transceivers 22 and related baseband (BB) circuitry 20, as well as appropriate user interface (UI) components 24 such as a touch-sensitive display screen, microphone and speaker(s). Other components, including one or more cameras, can also be present depending on the specifics of the system 10.

The various components depicted can be implemented as discrete packages. Alternatively one or more, or all, of these components can be integrated into a single package, such as in a system-on-a-chip (SOC) type of package.

The non-volatile mass storage device 18 can be a managed NAND type of device. The non-volatile mass storage device 18 includes a NAND flash (non-volatile) memory array 18A (NV Storage (NAND), an interface (IF) 18B provided for coupling to the data processor 12 via the bus 16 (e.g., an eMMC, UFS, or other type of wired interface) and a cache (volatile) memory 18C. Note that in some embodiments the non-volatile mass storage device 18 can be connected to the host via a wireless (e.g., a Bluetooth) connection, and thus the interface 18B (and a corresponding interface at the host) are constructed so as to permit the wireless connectivity. An optional non-volatile NV) cache 18E can also be provided, such as One based on NAND, PCM or DRAM with a battery backup capability. The NAND flash memory array 18A can be organized in any suitable fashion, such as by some number of blocks each containing some number of pages. A memory controller 18D is provided for managing the storage and retrieval of data in the flash memory array 18A, thereby hiding the specifics and complexities of the flash memory array organization from external devices, such as the data processor 12 which can be referred to as a host device. The memory controller 18D can be implemented, for example, as a state machine or as a processor that operates under control of a stored program. As shown the memory controller 18D includes a volatile cache interface 18F, a NAND interface 18G and an (optional) NV cache interface 18H. The memory controller 18D can also include an internal data buffer and an ECC (error correction code) engine (not shown).

In accordance with the exemplary embodiments of this invention various caching methods are provided.

Cache definition: A cache 18C address space is defined so that it exceeds the address space of the flash memory array 18A behind it. If it is desired to write to the flash memory array 18A through the cache 18C (faster initial access, flushing later) then this mode operates as in, for example, conventional SSD. However, if the host instead wants to quickly store some data which is not critical to survive a sudden power loss (e.g., cached web pages) then the host can write this data to an “out-of-the address space” of the cache 18C. In this case then the stored data resides only in the volatile memory (e.g., DRAM) of the cache 18C, and the stored data does not consume any of the system memory 14 DRAM space. In addition, the temporary storage of the data in the cache 18C does not accelerate the wearing out effect of the flash memory array 18A. In the case of a flush (a write-back) of the contents of the cache 18C to the flash memory array 18A the “out-of-the” address range cache data remains in the cache 18C and is not stored in the flash memory array 18A.

Cache implementation: The operation of the cache 18C can be supported by providing a definition in the applicable flash standard/data sheet that a component supports writing to the out-of-range address space in the cache 18C and that this data is not flushed to the flash memory array 18A.

An alternative method is to flush the out-of-range data by specific command/argument. This can be used to obtain free space in the cache 18C, especially in an implementation where there is information available concerning the cache 18C full state.

If the cache 18C becomes full then different algorithms can handle this occurrence so that new data would in any event be written to the cache 18C. This can be accommodated by selectively removing some data from the cache 18C (or simply over-writing some of the data) by the use of a first in first out (FIFO) algorithm or a least read first out (LRFO) algorithm, as two non-limiting examples.

There currently exists a block write method, such as one defined in the eMMC standard, which does not include a definitive indication of the amount of data to be written (a so called open ended multiple block write). This type of access is then terminated with specific command after all of the data blocks have been transferred. This type of operation can be problematic for cache access as it would be more efficient to cache short accesses while longer accesses would be more efficient to store directly to the flash. The implementation is preferably arranged so that if a stop command is received from the host before the internal buffer becomes full (the size of the buffer can be indicated in a register) then the data would actually be moved to the cache 18C (fast response time) rather than to the flash memory array 18A (longer response time). In this case it can be that only those accesses exceeding the buffering capability would be stored directly to the flash memory array 18A. This can be accommodated by the inclusion of a register which stores the information of the maximum access size for cache operations and that be read externally, e.g., by the data processor 12.

The exemplary embodiments of this invention may be particularly useful for so called ManagedNAND environments such as eMMC, SD, SSD, ONFI v3.0 EZNAND and UFS, although the embodiments can be used as well with conventional NAND, or earlier than v3.0 ONFI NANDs, etc. In a typical ManagedNAND device (such as eMMC) the address is a sector address. For example, in the eMMC case it is 32 bit sector (512 B) address, which implies a maximum address space size of 2 TB (terabytes). In SCSI (SSD, UFS) the 2 TB limitation is exceeded. As such, and even though in practice the exemplary embodiments can use additional address bit(s) to enlarge the cache address space, these bits in actuality already exist and are reserved for use in several standards that support 2 TB (and beyond) addressing modes. Thus, no change to the addressing modes is needed since the additional cache space, e.g., in a 64 GB (gigabyte) device, the address is generated to point to a 64+GB space for the enhanced cache access mode. Note also that the address is included within a command frame/protocol sent over the bus 16 and is not—a separate physical bit line(s) (e.g., as in a NOR flash/DRAM).

The size of the cache 18C is smaller than the size of the flash memory array 18A. As one non-limiting example a 64 GB flash memory array 18A can include a 1 GB DRAM cache 18C. In a typical case the memory controller 18D of the non-volatile mass storage device 18 is responsible for the caching algorithm. So as long as the host (e.g., the data processor 12) will access (write) the 0-64 GB address space the non-volatile mass storage device 18 utilizes the DRAM cache 18C in the most efficient manner. If the cache 18C begins to become full then a write-back of at least some of the cached data to the flash array 18A will occur (or the host may also trigger the write-back by issuing a flush command to the non-volatile mass storage device 18).

In the case where the host wishes to utilize the cache 18C for storing, for example, temporary web page data then the host can access, for example, the 64 GB-65 GB address space (there will be no automatic write-back from this address range). Again, it is the responsibility of the non-volatile mass storage device 18 to allocate and manage the actual physical DRAM memory related to this caching of data (this could be, for example, a dynamic cache management algorithm or some fixed range of cache 18C DRAM addresses allocated for this special range). Note that there is no direct one-to-one mapping between physical addresses of cache 18C DRAM and the flash memory array 18A.

It is within the scope of the exemplary embodiments to include a parameter in the access (write) from host which indicates to the memory controller 18D that this particular data does not require write-back. The use of this parameter is thus equivalent to an access made to the extended address range (e.g., to the 64-65 GB range when the flash memory array 18A has a maximum capacity of 64 GB).

It is also within the scope of the exemplary embodiments to include an indicator (bit) in a command sent by the host which specifies that the address used for temporarily cached data belongs to a separate cache address space than the address space used for flash accesses. This is equivalent to providing a cache 18C partition where a portion of the cache 18C is used to temporarily store data before it is written-back to the flash memory array 18A and where another portion of the cache 18C is used to store data that is not intended to be written-back to the flash memory array 18A. The partition P as shown in FIG. 1 can thus separate the cache memory 18C into a first partition or portion 19A of the cache 18C that is used to temporarily store data before write-back to the flash memory array 18A and into a second partition or portion 19B that is used to store data that is not intended to be written-back to the flash memory array 18A.

It is also within the scope of the exemplary embodiments to include an option in which data, which is originally marked by the host (e.g., data processor 12) to not require write-back to the non-volatile memory array 18A (e.g., data stored in the second portion 19B of the cache 18C) can be subsequently moved from one portion (partition) of the cache 18C to the other portion (partition) of the cache 18C. In this case the moved data would be written back to the flash memory array 18A. This option can be implemented by, for example, providing a command from the host that identifies the block of data previously written to the portion of the cache 18C that is not automatically flushed to the flash memory array 18A. In response to receiving this command the memory controller 18D can, for example, physically (or logically) move the block of data to the portion 19A of the cache 18C for subsequent write-back, or it may simply write-back the indicated block of data to the flash memory array 18A when it receives the command. An address conversion algorithm can be used to map the portion 19B of the cache 18C not intended to store data for write-back to the portion 19A that is intended to store data for write-back, or the address space of the portion 19B of the cache not intended to store data for write-back can be matched to the portion 19A that is intended to store data for write-back.

It can be noted that the foregoing embodiment, as well as other embodiments, can use various write back options such as writing back the data in response to a command by the host, writing back the data later autonomously by the memory device (controller 18D) as a background operation to the normal functioning of the memory device 18, or writing back the data later in response to a specific flush command received from the host.

In a still further embodiment there can be provided the true NV cache 18E in addition to the volatile (e.g., DRAM) cache 18C in the non-volatile mass storage device 18. The NV cache 18E can be part of the NAND already used for the main NV storage 18A, or a totally separate element. To avoid wearing out the main NV storage 18A a mechanism is provided to allow the originally marked and cached data (in cache 18C) to be moved from the volatile cache 18C to the NV cache 18E, without impacting the main NV storage array 18A. In this embodiment then the memory device 18 includes the volatile cache memory 18C and the non-volatile cache memory 18E, and there is an option to move stored data from the volatile cache memory 18C to the non-volatile cache memory 18E (and vice-versa) in response to a specific command received from the host or autonomously by action of the memory controller 18D.

It is also within the scope of the exemplary embodiments that only the marked data is written back to the non-volatile storage array 18A and non-marked data (by default) is explicitly not written back. Such a marking can include, for example, options that such marked data is allowed to be written back or is mandated to be written back. This embodiment would be applicable for a case of, by example, a DRAM extension module with small NV portion (e.g. boot storage).

Thus, it should be appreciated that the exemplary embodiments of this invention encompass, as examples, a case where an indication received with data indicates that the data does not need to be written back to the non-volatile memory array 18A, where a default operation is that data is written back; a case where an indication indicates that the data must not be written back to the non-volatile memory array 18A, where the default operation is that data is written back; a case where an indication indicates that the data is allowed to be written back to the non-volatile memory array 18A, where a default operation is that data is not written back; and a case where the indication indicates that data must be written back to the non-volatile memory array 18A, where the default operation is that data is not written back.

It is also within the scope of the exemplary embodiments to include as an option a use case for caching at one time only one small amount of data of a fixed size, a data “chink”. In this case there may be no address in the write command frame at all (the frame may be thus smaller in size than a frame with an address). Also in this case a bit may be provided to indicate if the address in the frame is a valid address or is not a valid address. Note that only in the partition 19B of the cache 18C that is used to store data that is not intended to be written-back to the flash memory array 18A is the cache address per se relevant, in all other cases the addresses are normal addresses to the media itself.

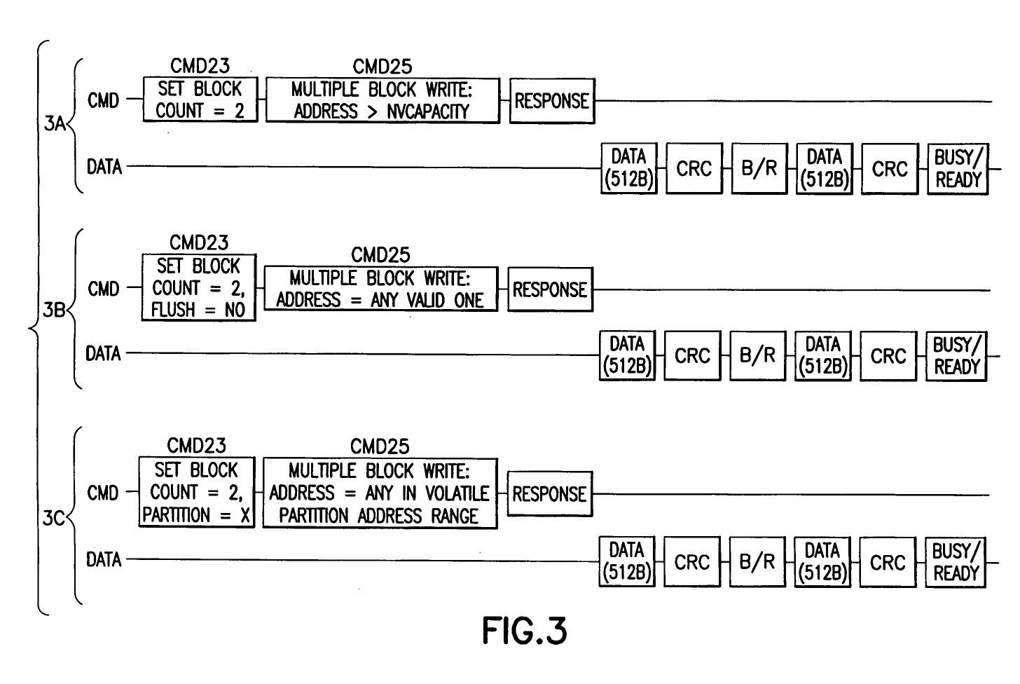

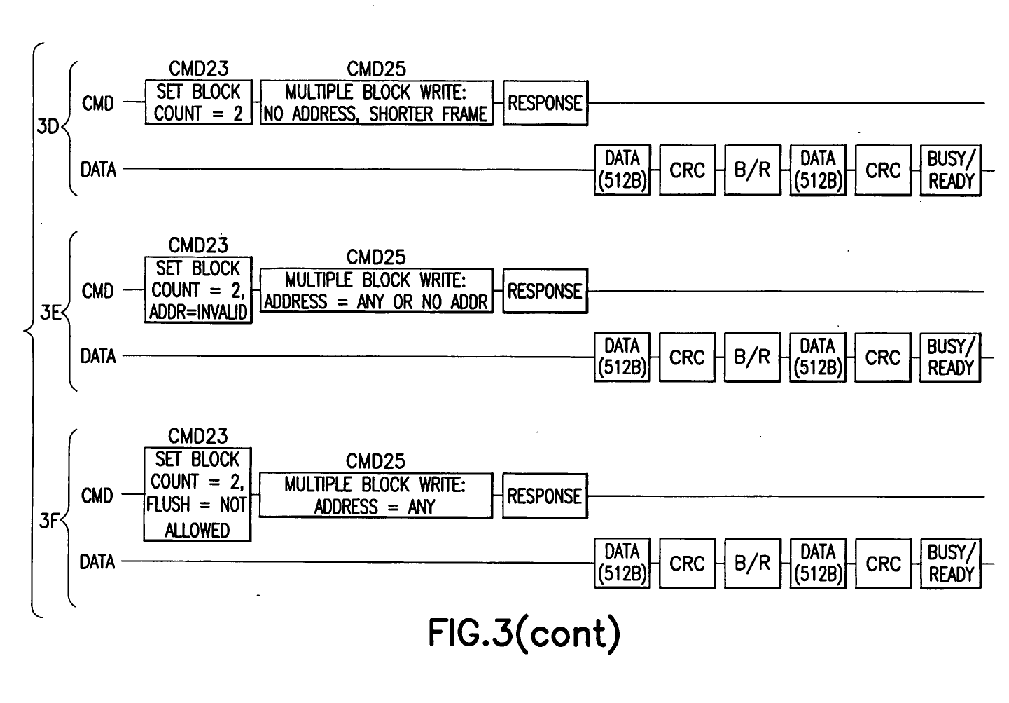

FIG. 3 depicts various command/data transaction sequences for communication with the non-volatile mass storage device 18 in accordance with embodiments of this invention. In these examples a command (CMD) bus and a data (DATA) bus are employed as per non-limiting example of the eMMC standard. In each example there are two commands issued, the first being referred to as CMD23 (set block count and other parameters) and the second as CMD25 (write multiple blocks).

In FIG. 3A CMD23 sets a block count to 2 while CMD25 indicates a multiple block write where the address that is provided is one that is greater than the capacity of the NV storage array 18A (Address>NVCapacity). Following a response from the non-volatile mass storage device 18 two data blocks, for example each of size 512 bytes, are transferred on the data bus. Each is acknowledged by a CRC and a busy/ready (B/R) indication from the non-volatile mass storage device 18. After the first B/R (ready) is received the second data block can be transferred.

In FIG. 3B the CMD23 sets the block count to 2 and sets a bit or bits that indicate that the data is not required to be flushed to the NV array 18A. In this case the address sent in the CMD25 can be any valid address. Following the response from the non-volatile mass storage device 18 two data blocks, each of size 512 bytes, are transferred on the data bus.

At the completion of either of these procedures a 1 kB chunk of data is stored in the DRAM volatile cache 18C, and an algorithm executed by the memory controller 18D positions the data at a suitable location in the cache 18C. The stored data is marked in some manner so that is can be physically/logically separated from the other cached data that will eventually be written-back to the NV storage array 18A. The marking can include, as non-limiting examples, allocating some specific physical DRAM address range in the cache 18C for the data chunk, or using a special argument byte related to the data that indicates that it is not to be written-back.

In FIG. 3C the CMD23 sets the block count to 2 and sets a partition indicator (a partition in the volatile cache 18C) to some value indicated as Partition=X. In this case the address sent in the CMD25 can be any valid address in the partition X. Following the response from the non-volatile mass storage device 18 two data blocks, each of size 512 bytes, are transferred on the data bus. At the completion of this procedure a 1 kB chunk of data is stored in the indicated partition of the DRAM volatile cache 18C. The partition in this case has an associated address space separate from the remainder of the storage device (e.g., address: 0x0000-0xFFFF, for a 64 kB partition address space).

In FIG. 3D CMD23 sets the block count to 2 and CMD25 indicates a multiple block write. However, no address is provided (the frame is thus made shorter). Following the response from the non-volatile mass storage device 18 two data blocks, each of size 512 bytes, are transferred on the data bus. In this case the memory controller 18D interprets the absence of the address as a command to store the two blocks of data and to mark the 1 kB data chunk in some manner so that is can be physically/logically separated from the other cached data that will eventually be written-back to the NV storage array 18A.

FIG. 3E is similar in some respects to the embodiment of FIG. 3C. In FIG. 3E CMD23 sets the block count to 2 and sets a bit or bits that indicate that any following address is invalid. In this case an address sent in the CMD25 can be any address, or no address need be provided. Following the response from the non-volatile mass storage device 18 two data blocks, each of size 512 bytes, are transferred on the data bus. In this case the memory controller 18D simply ignores any address that may or may not be sent in the CMD25, and interprets the invalid address indication in the CMD23 as a command to store the two blocks of data and to mark the 1 kB data chunk in some manner so that is can be physically/logically separated from the other cached data that will eventually be written-back to the NV storage array 18A.

FIG. 3F is similar in some respects to the embodiments of FIGS. 3B and 3E. In FIG. 3F CMD23 sets the block count to 2 and sets a bit or bits that indicate that a flush of the data to be sent is explicitly not allowed. In this case an address sent in the CMD25 can be any address. Following the response from the non-volatile mass storage device 18 two data blocks, each of size 512 bytes, are transferred on the data bus. In this case the memory controller 18D interprets the flush not allowed indication in the CMD23 as a command to store the two blocks of data and to mark the 1 kB data chunk in some manner so that is can be physically/logically separated from the other cached data that will eventually be written-back to the NV storage array 18A.

In all of these various embodiments a flush command can be subsequently received from the host and in response the memory controller 18D performs a write-back to the non-volatile memory array 18A of at least some data stored in the cache memory 18C that does not have the indication that there is no write-back requirement for the data. In this case the write-back can occur autonomously by the memory device (controller 18D) in the background.

A number of advantages and technical effects are obtained by the use of the exemplary embodiments. These include, but are not limited to, increased performance (both system and memory), increased lifetime of the system 10 due to a longer lifetime of the non-volatile mass memory 18, an increased reliability due at least to a reduced NAND block PE count, and improved data retention. In addition, the use of the exemplary embodiments can conserve the data storage capability of the system memory 14 by enabling some (non-critical) data to be off-loaded to the cache 18 of the non-volatile memory device 18.

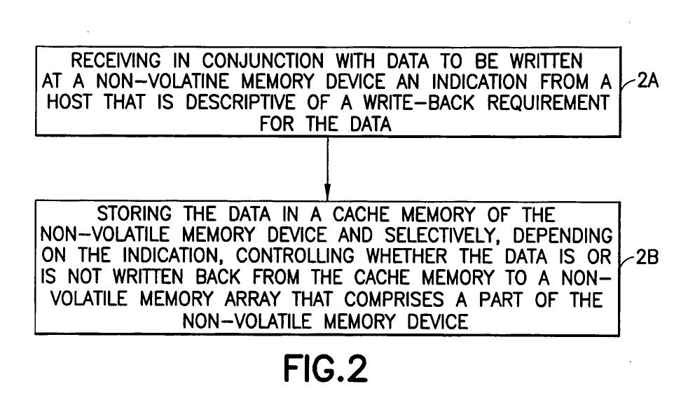

FIG. 2 is a logic flow diagram that shows a method in accordance with the exemplary embodiments of this invention. At Block 2A there is a step of receiving in conjunction with data to be written at a non-volatile memory device an indication from a host that is descriptive of a write-back requirement for the data. At Block 2B there is a step of storing the data in a cache memory of the non-volatile memory device and selectively, depending on the indication, controlling whether the data is or is not written back from the cache memory to a non-volatile memory array that comprises a part of the non-volatile memory device.

In the method as depicted in FIG. 2, where the indication comprises an address in a range that exceeds an addressable range of the non-volatile memory array.

In the method as depicted in FIG. 2, where the indication comprises at least one bit indicating that there is no write-back requirement for the data.

In the method as depicted in FIG. 2, where the indication comprises an address associated with an address space (19B) separate from an address space associated with the non-volatile memory array (18A/19A)

In the method as depicted in FIG. 2, where the data is received without a valid address.

In the method as depicted in FIG. 2, where the indication indicates that the data is only to be stored in the cache memory and that write-back is explicitly prohibited.

In the method as depicted in FIG. 2 and in any one of the preceding paragraphs descriptive of FIG. 2, and further comprising a step of subsequently writing-back to the non-volatile memory array the stored data that was received with an indication that the data should not be written-back to the non-volatile memory array, thereby over-riding the previously received indication.

In the method as in the preceding paragraph, where writing back the stored data occurs in response to a command by the host, or autonomously by a controller of the non-volatile memory device in the background, or in response to a specific flush command by the host.

In the method as depicted in FIG. 2 and in any one of the preceding paragraphs descriptive of FIG. 2, and further comprising in response to receiving a flush command from the host, or autonomously by the non-volatile memory device, writing-back to the non-volatile memory array at least some data stored in the cache memory that does not have an indication that there is no write-back requirement for the data.

In the method as depicted in FIG. 2 and in any one of the preceding paragraphs descriptive of FIG. 2, where the cache memory is a volatile cache memory, where the memory device also comprises a non-volatile cache memory, and further comprising moving stored data between the volatile cache memory and the non-volatile cache memory in response to a specific command by the host or autonomously by a controller of the memory device.

In the method as depicted in FIG. 2 and in any one of the preceding paragraphs descriptive of FIG. 2, where the host is comprised of a data processor of a mobile device in which the non-volatile memory device is embedded or to which the non-volatile memory device is attached via a wired or a wireless connection.

In the method as depicted in FIG. 2 and in the preceding paragraph, where the mobile device has wireless communication capability.

The memory controller 18D may also comprise at least one processor device that operates under the control of a stored program. As such, the exemplary embodiments of this invention also encompass a non-transitory computer-readable medium that contains software program instructions, where execution of the software program instructions by the at least one processor results in performance of operations that comprise execution of the method as depicted in FIG. 2 and in any one of the preceding paragraphs descriptive of FIG. 2.

The exemplary embodiments also pertain to an apparatus that comprises an interface for connecting the apparatus to a host; a volatile cache memory; a non-volatile memory array; and a controller connected with said interface, the cache memory and the non-volatile memory array. The controller is responsive to a receipt of data from the host with an indication descriptive of a no write-back requirement for the data to store the data in the cache memory and to selectively, depending on the indication, control whether the data is or is not written back from said cache memory to said non-volatile memory array.

The exemplary embodiments also pertain to an apparatus that comprises an apparatus that comprises means for receiving in conjunction with data to be written an indication from a host that is descriptive of a write-back requirement for the data; and means, for storing the data in a volatile cache memory of a memory device and for selectively, depending on the indication, controlling whether the data is or is not written back from the volatile cache memory to a non-volatile memory array of the memory device. The indication comprises at least one of an address in a range that exceeds an addressable range of the non-volatile memory array, at least one bit indicating that there is no write-back requirement for the data, an address associated with an address space separate from an address space associated with the non-volatile memory array, and a receipt of the data without a valid address. In this apparatus the means for receiving and the means for storing can be embodied as circuitry (hardware) such as a state machine or a programmed data processor, and thus can also be embodied as software, such as computer program instructions stored in a non-transitory computer readable medium. The means for receiving and the means for storing can also be embodied as a combination of circuitry (hardware) and software, such as computer program instructions stored in a non-transitory computer readable medium.

The foregoing description has provided by way of exemplary and non-limiting examples a full and informative description of various method, apparatus and computer program software for implementing the exemplary embodiments of this invention. However, various modifications and adaptations may become apparent to those skilled in the relevant arts in view of the foregoing description, when read in conjunction with the accompanying drawings and the appended claims. As but some examples, the use of other similar or equivalent storage sizes and non-volatile memory technologies may be attempted by those skilled in the art. However, all such and similar modifications of the teachings of this invention will still fall within the scope of the embodiments of this invention.

Furthermore, some of the features of the exemplary embodiments of this invention may be used to advantage without the corresponding use of other features. As such, the foregoing description should be considered as merely illustrative of the principles, teachings and embodiments of this invention, and not in limitation thereof.

1. A method, comprising:
receiving in conjunction with data to be written at a non-volatile memory device an indication from a host that is descriptive of a write-back requirement for the data; and
storing the data in a cache memory of the non-volatile memory device and selectively, depending on the indication, controlling whether the data is or is not written back from the cache memory to a non-volatile memory array that comprises a part of the non-volatile memory device.

2. The method as in claim 1, where the indication comprises an address in a range that exceeds an addressable range of the non-volatile memory array.

3. The method as in claim 1, where the indication comprises at least one bit indicating that there is no write-back requirement for the data.

4. The method as in claim 1, where the indication comprises an address associated with an address space separate from an address space associated with the non-volatile memory array.

5. The method as in claim 1, where the data is received without a valid address.

6. The method as in claim 1, where the indication explicitly indicates that the data is only to be stored in the cache memory and not stored in the non-volatile memory array thereby expressly inhibiting write-back of the data.

7. The method as in claim 1, further comprising writing-back to the non-volatile memory array the stored data that was previously received with an indication that the data should not be written back to the non-volatile memory array, thereby over-riding the previously received indication, where writing back the stored data occurs in response to a command by the host, or autonomously by a controller of the non-volatile memory device in the background, or in response to a specific flush command by the host.

8. The method of claim 1, where the cache memory is partitioned into a first portion that stores data that is intended to be stored into the non-volatile memory array and a second portion that stores data that is not intended to be stored into the non-volatile memory array.

9. The method of claim 1, further comprising receiving a flush command from the host and in response writing-back to the non-volatile memory array at least some data stored in the cache memory that does not have the indication that there is no write-back requirement for the data.

10. The method of claim 1, where the cache memory is a volatile cache memory, where the memory device also comprises a non-volatile cache memory, and further comprising moving stored data between the volatile cache memory and the non-volatile cache memory in response to a specific command by the host or autonomously by a controller of the memory device.

11. The method of claim 1, where the host is comprised of a data processor of a mobile device in which the non-volatile memory device is embedded or to which the non-volatile memory device is attached via a wired or a wireless connection.

12. The method of claim 11, where said mobile device has wireless communication capability.

13. A non-transitory computer-readable medium that contains software program instructions, where execution of the software program instructions by at least one data processor results in performance of operations that comprise execution of the method of claim 1.

14. An apparatus, comprising:
an interface for connecting said apparatus to a host;
a volatile cache memory;
a non-volatile memory array; and
a controller connected with said interface, said cache memory and said non-volatile memory array, said controller being responsive to a receipt of data from the host with an indication that is descriptive of a write-back requirement for the data, where said controller stores the data in said cache memory and selectively, depending on the indication, controls whether the data is or is not written back from said cache memory to said non-volatile memory array.

15. The apparatus as in claim 14, where the indication comprises an address in a range that exceeds an addressable range of said non-volatile memory array.

16. The apparatus as in claim 14, where the indication comprises at least one bit indicating that there is no write-back requirement for the data.

17. The apparatus as in claim 14, where the indication comprises an address associated with an address space separate from an address space associated with said non-volatile memory array.

18. The apparatus as in claim 14, where the data is received without a valid address.

19. The apparatus as in claim 14, where the indication explicitly indicates that the data is only to be stored in said cache memory and not stored in said non-volatile memory array thereby expressly inhibiting write-back of the data.

20. The apparatus as in claim 14, where said controller write-backs to said non-volatile memory array the stored data that was previously received with an indication that the data should not be written-back to said non-volatile memory array, thereby over-riding the previously received indication, where the write-back of the stored data occurs in response to a command by the host, or autonomously by a controller of the non-volatile memory device in the background, or in response to a specific flush command by the host.

21. The apparatus as in claim 14, where said cache memory is partitioned into a first portion that stores data that is intended to be stored into said non-volatile memory array and a second portion that stores data that is not intended to be stored into said non-volatile memory array.

22. The apparatus as in claim 14, further comprising a non-volatile cache memory, and where said controller is further configured to move stored data between the volatile cache memory and the non-volatile cache memory in response to a specific command by the host or autonomously.

23. The apparatus as in claim 14, where said apparatus is embodied in or is connected to a mobile device via a wired or a wireless connection, where said mobile device has wireless communication capability.

24. An apparatus, comprising:
means for receiving in conjunction with data to be written an indication from a host that is descriptive of a write-back requirement for the data; and
means for storing the data in a volatile cache memory of a memory device and for selectively, depending on the indication, controlling whether the data is or is not written back from the volatile cache memory to a non-volatile memory array of the memory device, where
the indication comprises at least one of an address in a range that exceeds an addressable range of the non-volatile memory array, at least one bit indicating that there is no write-back requirement for the data, an address associated with an address space separate from an address space associated with the non-volatile memory array, and a receipt of the data without a valid address.

25. The apparatus as in claim 24, where said storing means writes-back to the non-volatile memory array the stored data that was previously received with an indication that the data should not be written-back to said non-volatile memory array, thereby over-riding the previously received indication, where the write-back of the stored data occurs in response to a command by the host, or autonomously by a controller of the non-volatile memory device in the background, or in response to a specific flush command by the host.

26. The apparatus of claim 24, where said volatile cache memory is partitioned into a first portion that stores data that is intended to be stored into the non-volatile memory array and a second portion that stores data that is not intended to be stored into the non-volatile memory array.

27. The apparatus as in claim 24, where the host is comprised of a data processor of a mobile communication device in which the memory device is embedded or to which the memory device is attached via a wired or a wireless connection.
